(19) United States
(12) Patent Application Publication
(10) Pub. No.: US 2007/0280143 A1
(43) Pub. Date: Dec. 6, 2007

(54) LICENSING CONTROL MECHANISM AND PARTICIPANT REGISTRATION PROCESS USING A GROUP RESPONSE SYSTEM

(75) Inventors: Michael P. Crosby, Cortland, OH (US); Kevin G. Adkins, Akron, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(73) Assignee: Turning Technologies, LLC, Youngstown, OH (US)

(21) Appl. No.: 11/758,460

(22) Filed: Jun. 5, 2007

Related U.S. Application Data
(60) Provisional application No. 60/803,901, filed on Jun. 5, 2006.

(51) Int. Cl. H04L 12/16

(52) U.S. Cl. 370/259

(57) ABSTRACT

An audience response system includes a peripheral machine device capable of storing data and input/output circuitry physically connected to the transmitter unit and configured to enable operative communication between the peripheral machine device and the processor logic, where the processor logic disables selected functionality of the transmitter unit until valid data passes from the peripheral machine device and the processor logic.

### RELATED APPLICATIONS

This non-provisional application claims the benefit of U.S. Provisional Application No. 60/803,901 filed Jun. 5, 2006.

### BACKGROUND

This specification relates to the networking arts. In one embodiment, its teachings find application in networks that collect data from a plurality of spaced transmitters such as audience response systems.

Audience response systems typically use a plurality of wired or wireless transmitters to send data, including user responses and/or answers to one or more centrally located receivers. In some networks, it is not important to have particular transmitters associated with particular users. Such anonymous networks include conference settings or generally environments where the collected data itself is of independent value or interest or user anonymity is desired. Occasionally, transmitter licenses expire or software updates are required but this information may not be provided to the network in time to permit that transmitter's data to be accepted in a particular session or until such time as the defect is noticed independently.

In other networks, it is desirable to maintain a one-to-one correlation of transmitters to users. Such networks include those in the classroom or testing setting where the network is helpful for an instructor or moderator to identify individuals who are participating or who need additional discussion on a particular topic. Often instructors assign an identifiable transmitter to an individual who is then assumed to be the sole user. Then, data collected from that transmitter is attributed to the assigned individual.

### BRIEF DESCRIPTION OF THE DRAWINGS

In the accompanying drawings which are incorporated in and constitute a part of the specification, embodiments are illustrated which, together with the detailed description given below, serve to describe exemplary embodiments. It will be appreciated that the illustrated boundaries of elements (e.g. boxes, groups of boxes, or other shapes) in the figures represent but exemplary boundaries. One of ordinary skill in the art will appreciate, for example, that one element may be designed as multiple elements or that multiple elements may be designed as one element. An element shown as an internal component of another element may be implemented as an external component and vice versa. The drawings and components therein are not to any scale. Certain components may be omitted and others shown enlarged to facilitate understanding.

FIG. 1 is a diagram illustrating an embodiment of a device capable of performing aspects of the present disclosure.

FIG. 2 is a diagram illustrating an embodiment of a device capable of performing aspects of the present disclosure.

FIG. 3 is a simplified diagram illustrating communication between devices capable of performing aspects of the present disclosure.

FIG. 4 is a simplified diagram illustrating communication between devices capable of performing aspects of the present disclosure.

FIG. 5 is a simplified diagram illustrating communication between devices capable of performing aspects of the present disclosure.

FIG. 6 is a flowchart illustrating an exemplary method for performing aspects of the present disclosure.

FIG. 7 is a flowchart illustrating an exemplary method for performing aspects of the present disclosure.

FIG. 8 is a flowchart illustrating an exemplary method for performing aspects of the present disclosure.

FIG. 9 is a diagram illustrating embodiments of devices capable of performing aspects of the present disclosure.

FIG. 10 is a diagram illustrating embodiments of devices capable of performing aspects of the present disclosure.

### DETAILED DESCRIPTION

Generally speaking, one embodiment of a system and method is provided to register transmitters and users in an audience response collecting session. Such a session may include collecting and transmitting real-time, or storing for future transmission, answers, replies, selections, responses or options; to tests, quizzes, polls, queries, surveys, scoring or performance monitoring situations, or opinions. Stimuli for user responses include audio, visual, oral, observed or written interactivity. In one example, system transmitters can include stored user identifying data or transmitters may be adapted to read such data from a machine readable medium in operable connection with the transmitter. Upon initiation of device registration, the transmitter may format a registration package including user identifying data, device identifying data, license information and the like. Once prepared, the transmitter may transmit the package to a response collecting processor for validation and registration.

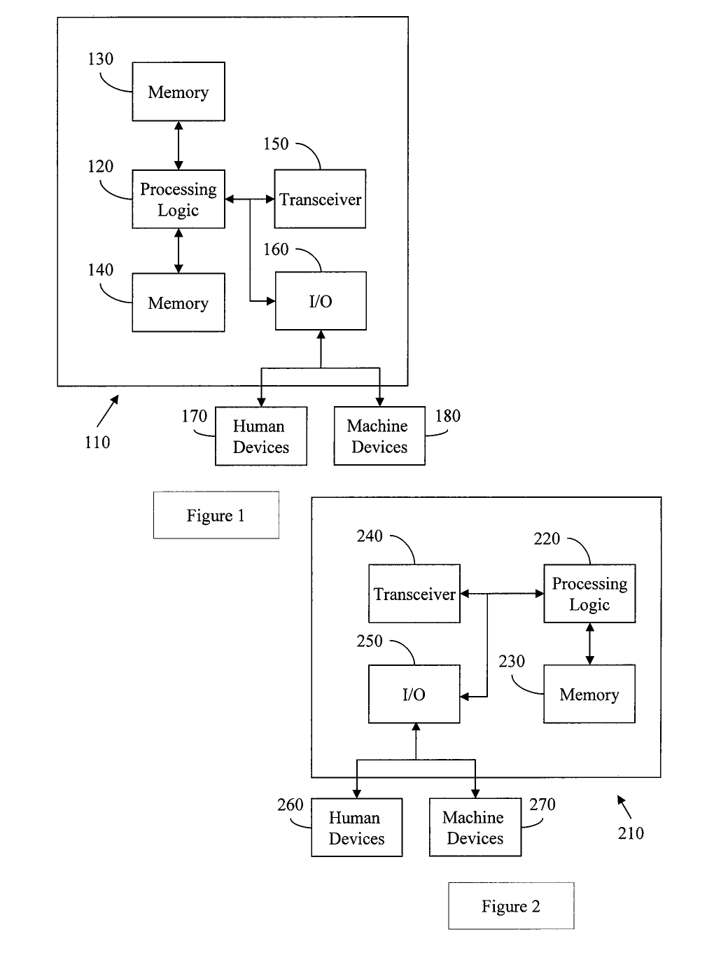

FIG. 1 illustrates an example block diagram of a user transmitter device 110. Preferably the device 110 is adapted to be hand carried and may be operable with a keyboard, keypad, touch sensitive screen, GUI and the like. The device 110 may be controlled by a processing logic 120 that may be in data communication with a first machine readable medium 130 configured to contain operating instructions, for example, embodied as software code. The processor may be in data communication with a second machine readable medium 140, configured to contain user information such as name, identifying numbers (e.g. social security number, an assigned identifying number, and the like). In addition, the second machine readable medium 140 may also contain license information, operating system version identifiers, historical use information and other desired data.

It is appreciated that while the description and illustration of two machine readable media are presented for ease of distinction and understanding, the separation may be logical, physical, machine addressable and the like. In other words, the device 110 may have a single memory partitioned or otherwise segregated with operating software in one logical area and user information in another. Alternatively, the device 110 may employ a single internal memory configured to contain an operating system, with a physically separate, internal memory configured to retain the user information. In yet another embodiment, the device 110 may contain an internal memory with operating instructions and an externally connectable memory device such as a memory stick, USB flash memory, magnetic strip and the like with user identifying and licensing data. Variations and combinations of the embodiments discussed, alone or with other known means may be substituted without departing from the teachings here.

With continued reference to FIG. 1, the device 110 may also include transceiver 150 configured to communicate signals from the device 110 to a response collection system. The transceiver 150 may communicate using any known means or those later developed such as radio frequency, light, electrical or magnetic signals and may be wireless or wired. The device may also include input/output logic 160 to enable operative communication with peripheral devices including human devices 170 for interaction primarily with the human sensory system and machine devices 180 for interaction primarily with machines. The human devices 170 may include screens, displays, speakers, keypads, keyboard, pointer devices, joysticks and the like. The machine devices 180 may include processors, logic, or other devices for storing, creating, modifying, sending, and/or receiving signals.

With reference now to FIG. 2, a response collection system 210 may be controlled by processing logic 220 that may be in data communication with a machine readable medium 230 configured to contain operating instructions, for example, embodied as software code. Machine readable medium 230 may also be configured to store group response software, particular presentations and user registration data, audience responses, statistics and like. The system 210 may also include transceiver 240 configured to receive or exchange signals from a user or participant transmitter. The transceiver 240 may communicate using any known means or those later developed such as radio frequency, light, electrical or magnetic signals and may be wireless or wired. The device may also include input/output logic 250 to enable operative communication with peripheral devices including human devices 260 for interaction primarily with the human sensory system and machine devices 270 for interaction primarily with machines.

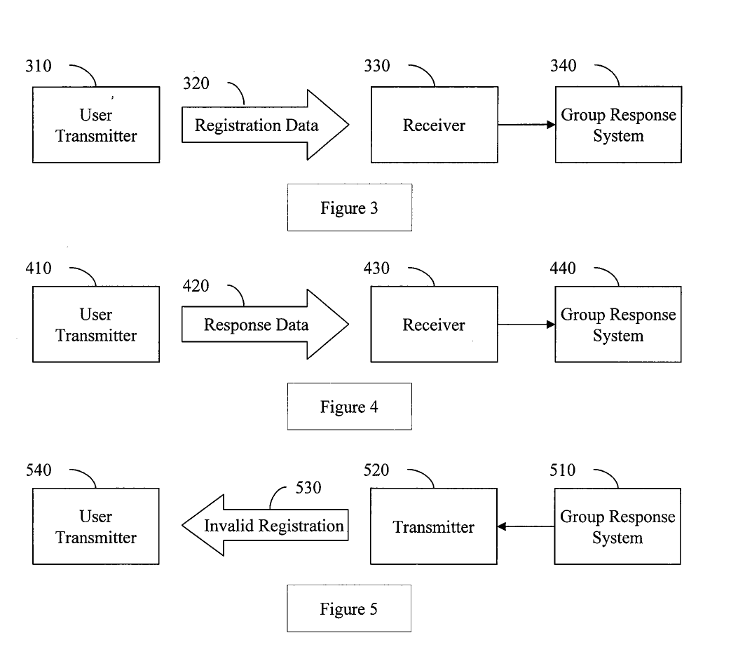

With reference now to FIG. 3, a user transmitter 310 may initiate a registration process via, for example, manual action such as a combination of key presses or the process may be commenced by automated methods such as upon receipt of a send request, polling request or instruction from a response system. The transmitter 310 formats registration data and sends signals 320 corresponding to the registration data to a receiver 330 in operable connection with a response system 340. As further discussed below, the response system 340 may then process the registration data. In one embodiment, the registration data may include only a transmitter identifier, so that the response system may uni-directionally receive, or multi-directionally poll or request data from the transmitter when responses are sought. In another embodiment, the registration data may include user identifying information so that responses may be associated with a particular user. In yet another embodiment, registration data may include license information or other data relating to transmitter software.

Referring now to FIG. 4, if the registration process succeeds, the transmitter 410 may then participate in an audience response session. During a session, the transmitter 410 occasionally formats a response, such as to a proffered query, and transmits signals 420 corresponding to the response. The transmission can be triggered by a polling request from the response system or by a send request such as user action on the transmitter 410 (e.g. a key press). The response may then be received at a receiver 430 in operable connection with a response system 440, and processed accordingly.

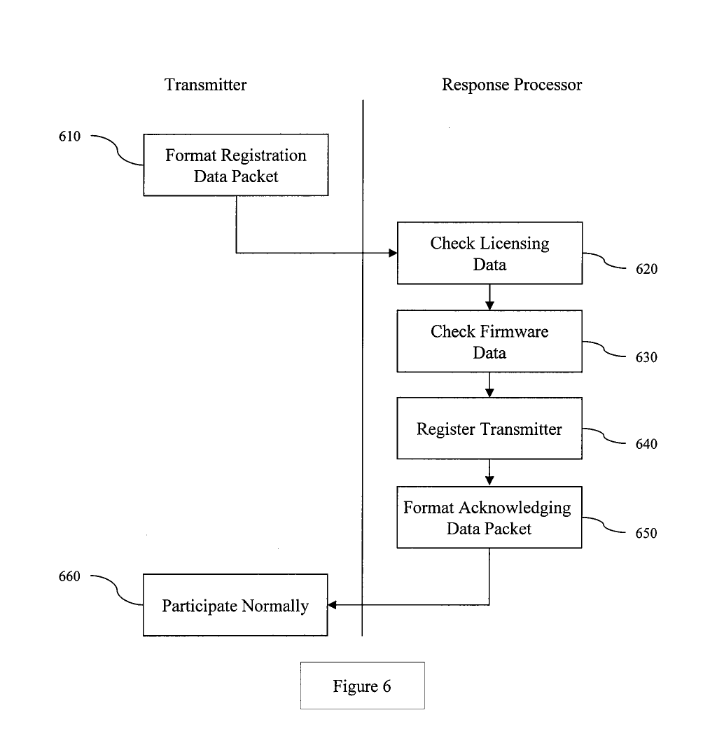

Referring now to FIG. 5, if the registration process fails, the response system 510 may format an invalid registration packet which is transmitted by a transmitter 520. Signals 530 corresponding to the invalid registration packet are received by a transmitter 540 and processed. In one embodiment, a user may receive an indication that the registration failed and that the user will be unable to participate in the audience response session. In another embodiment, the transmitter disables transmission or completely powers down until the failure is remedied. Such a remedy may be obtaining proper licensing, updating records and the like.

Referring now to FIG. 6, in one embodiment a transmitter may format a registration packet 610 including license data such as expiration date, version and the like corresponding to the transmitter software, in this instance embodied as firmware. The packet is communicated to the response processor, for example over a wireless signal communication protocol. The response processor decodes the packet and checks licensing data, 620. If the license is current, the firmware data, such as firmware version, is checked, 630. If both the license and firmware checks prove valid, the response processor registers the transmitter, 640. Optionally, the response processor may then format an acknowledgement data packet 650 for communication to the transmitter. Once received at the transmitter the acknowledgement is decoded if needed, and displayed to the user. The transmitter may then participate in the audience response session, 660. In the event either the licensing data check 620 or firmware data check 630 are invalid, then the response processor does not register the transmitter, and the transmitter is not able to participate in the audience response session.

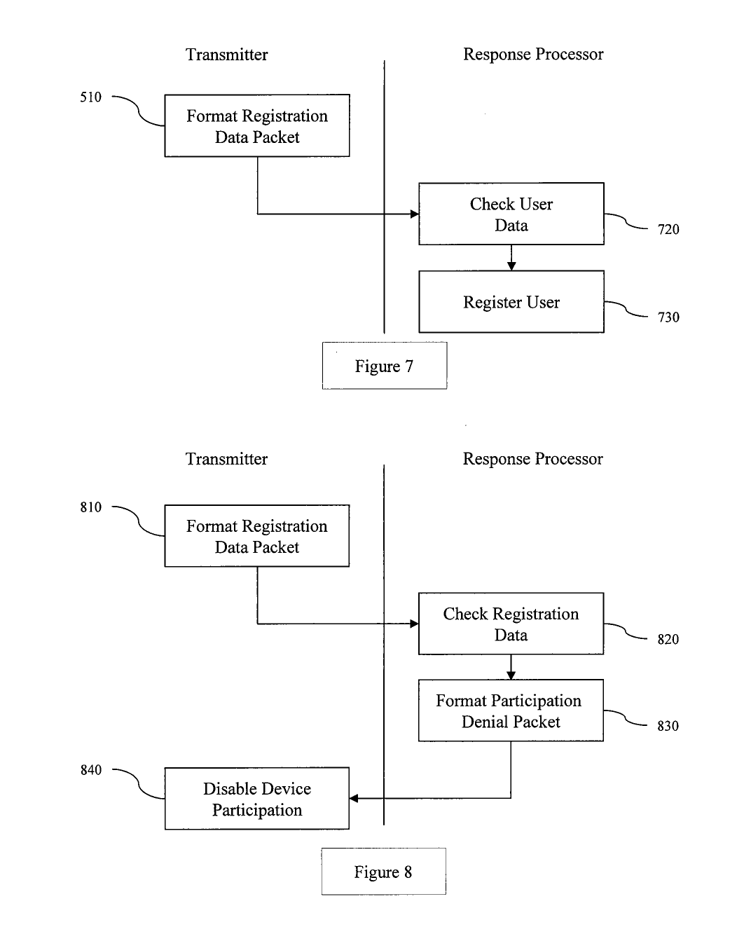

With reference to FIG. 7, in one embodiment a transmitter may format a registration packet 710, for example in response to a registration trigger generated either by a user or by a response system. Here, the packet may include data that identifies a user. The user identification data may be loaded into the device or contained on other machine readable media that can be associated with the transmitter only during the registration process or anytime when the transmitter is to be used. The user data may include employee identifiers, student identifiers, or registrant data that may or may not be associated with a particular person. The packet is communicated to the response processor, for example, over a wired signal communication protocol. The response processor decodes the packet and checks user data, 720. If the data meets acceptance criteria, the response processor causes the transmitter to be registered, 730. In the user data is determined to be invalid, then the response processor does not register the transmitter, and the transmitter is not able to participate in the audience response session.

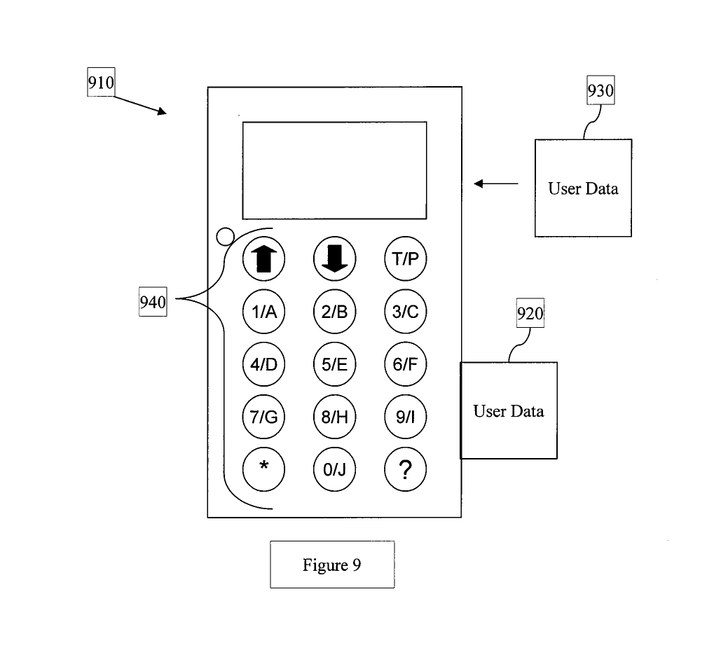

With reference now to FIG. 8, in one embodiment a transmitter may format a registration packet 810. The packet may then be communicated to a response processor, for example, using a radio frequency signal communication protocol. The response processor decodes the packet and checks registration data, 820. Should the registration data not satisfy registration parameters, the response processor may format a participation denial packet, 830. The denial packet may include an error code or display explaining why participation is denied, and/or may cause the transmitter to become inoperative until the condition is remedied. The packet is communicated to the transmitter, and the device may be disabled from participation, 840.

With reference now to FIG. 9, a transmitter device 910 is shown with logic 920, for example a USB flash memory device, attached. Logic 920 may contain user identification data, license data and the like, be readable, writable or either selectively. In one embodiment, the logic 920 may be attached for the registration process. Here, internal transmitter logic may read the required data from the logic as needed to prepare a registration packet. After registration, the logic 920 may be removed while the transmitter participates in the audience response session. In another embodiment, the logic 920 may be required to maintain connection to the transmitter 910 to continue participation in the audience response session. In yet another embodiment, the transmitter device may include machine readable media for retaining user and/or licensing data. In this embodiment, the required information may be provided to the machine readable medium specifically over a wireless link, for example, or other peripheral machine device 930 in operable communication with the transmitter 910. In another embodiment, a user may slide a magnetic strip encoding the desired data through a reader in the transmitter 910. In yet another embodiment, a user may enter the data in response to prompts or otherwise on the transmitter keypad 940 or other peripheral human device.

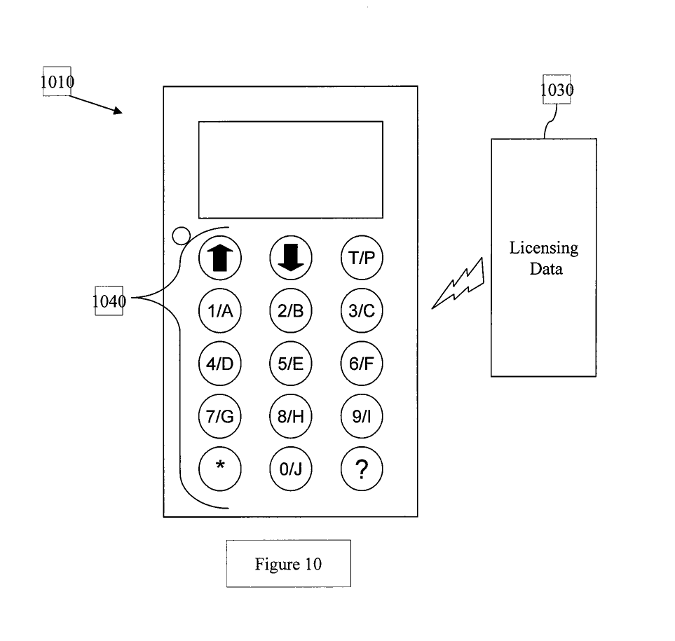

With reference now to FIG. 10, a transmitter device 1010 is shown with logic 1030, for example a proximity card in communication. Logic 1030 may contain user identification data, license data, firmware updates and the like. In one embodiment, the logic 1030 may be closely positioned for the registration or update process. Here, logic internal to the transmitter 1010 may read or receive the required data from the logic as needed to prepare a registration packet. After registration, the logic 1030 may be stored while the transmitter participates in the audience response session. In another embodiment, the logic 1030 may be required to maintain communication with the transmitter 1010 to continue participation in the audience response session. In yet another embodiment, the transmitter device may include machine readable media for retaining user and/or licensing data. In this embodiment, the required information may be provided to the machine readable medium specifically over a wireless link, for example, or other peripheral machine device 1030 in operable communication with the transmitter 1010. In another embodiment, logic 1030 may communicate via wireless 802.11 protocol, for example, through a receiver in the transmitter 1010. In yet another embodiment, a user may enter the data in response to prompts or otherwise on the transmitter keypad 1040 or other peripheral human device, such as keypad, GUI and the like.

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Similarly, when the applicants intend to indicate “one and only one” of A, B, or C, the applicants will employ the phrase “one and only one”. Thus, use of the term “or” herein is the inclusive, and not the exclusive use.

What is claimed is:

1. In an audience response system comprising a plurality of transmitter units where each transmitter unit includes a unique address, means for receiving a user input and processor logic configured to format data corresponding to the unique address and the user input for communication to a physically spaced receiver unit having means for receiving the formatted data, the improvement comprising:
a peripheral machine device capable of storing data; and
input/output circuitry physically connected to the transmitter unit and configured to enable operative communication between the peripheral machine device and the processor logic, where the processor logic disables selected functionality of the transmitter unit until valid data passes from the peripheral machine device and the processor logic.

2. The system as set forth in claim 1, where the peripheral machine device comprises a computer-readable medium configured to store transmitter unit license data.

3. The system as set forth in claim 1, where the peripheral machine device comprises a computer-readable medium configured to store user identifying data.

4. The system as set forth in claim 1, further comprising a user perceptible event at the transmitter unit associated with passage of valid data from the peripheral machine device to the processor logic.

5. The system as set forth in claim 1, further comprising a user perceptible event at the transmitter unit associated with passage of invalid data from the peripheral machine device to the processor logic.

6. The system as set forth in claim 1, further comprising a user perceptible event at the transmitter unit associated with passage of valid data from the transmitter to the physically spaced receiver unit.

7. An audience response system comprising:
at least one handheld transmitter configured to transmit wireless response signals in response to a user action, the handheld transmitter including:
a first computer-readable medium configured to store user particular data, the first computer-readable medium user being user attachable to the handheld transmitter;
a second computer-readable medium integral with the handheld transmitter configured to store handheld transmitter particular data; and
at least one central response processor configured to receive the wireless response signals from the transmitter and selectively permit participation of the handheld transmitter.

8. The system as set forth in claim 7, where the user particular data is selected from at least one of the group of name, identifier, and license data.

9. The system as set forth in claim 7, where the handheld transmitter further comprises an input mechanism configured to establish data communication between the first computer-readable medium and a processor integral with the handheld transmitter.

10. The system as set forth in claim 9, where the input mechanism is selected from the group of USB port, serial port, parallel port, WiFi—IEEE 802.11 receiver, infra-red receiver, FireWire—IEEE 1394 receiver, memory stick port, flash memory port, proximity card reader and biometric reader.

11. A method of authorizing transmitters to participate in an audience response network comprising:
receiving signals from a transmitter;
decoding data from the received signals;
determining from the decoded data whether the transmitter possesses sufficient rights to participate in the network; and
sending acknowledging data to the transmitter indicative of authorization for transmitter participation.

12. The method of claim 11 where the acknowledging data comprises transmitter denial data indicative of unsuccessful authorization.

13. The method of claim 11 where the acknowledging data comprises transmitter acceptance data indicative of successful authorization.

14. The method of claim 13 where, following sending of the acknowledging data, accepting responses from the transmitter where the responses include handheld transmitter particular data.
